(19) United States
(12) Patent Application Publication
(10) Pub. No.: US 2011/0078188 A1
(43) Pub. Date: Mar. 31, 2011

(54) Mining and Conveying Social Relationships

(75) Inventors: Hang Li, Beijing (CN); Yunhua Hu, Redmond, WA (US); Xin Zou, Beijing (CN); Xiaoyuan Cui, Redmond, WA (US); Weijiang Xu, Beijing (CN); Congrui Ji, Beijing (CN); Ruochi Zhang, Beijing (CN); Guangping Gao, Beijing (CN)

(73) Assignee: Microsoft Corporation, Redmond, WA (US)

(21) Appl. No.: 12/568,622

(22) Filed: Sep. 28, 2009

(51) Int. Cl. G06F 17/30; G06F 3/00

(52) U.S. Cl. 707/776; 715/762; 707/E17.03

(57) ABSTRACT

Techniques and tools described herein mine social information from a source and store the social information in a database. Responsive to a search object, the techniques search the stored social information and determine social relationships. The techniques further provide, via a graphical user interface, the social relationships determined from the social information stored in the database. In several embodiments, the techniques enable social relationship feedback.

### COPYRIGHT NOTICE

A portion of the disclosure of this patent document contains material which is subject to copyright or protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Currently, the number of people who are connected to, participate in, or are members of an organizational group continues to increase. Furthermore, as new modes of communication becomes more prevalent with the aid of computers, PDAs, the Internet, email, discussion threads, etc., social information associated with people in an organizational group and social information communicated between people in an organizational group is also becoming more voluminous. As a result, social relationships between two or more people develop even though the people may be located in different parts of the world, and perhaps have never even met.

Identifying the basis of social relationships in an enterprise environment may be useful when a question needs to be answered, for example, and may provide important information with regard to the organizational group.

### SUMMARY

This document describes tools for mining social information from a source in an enterprise environment, and storing the social information in a database. Responsive to a search object, the tools search the stored social information and determine social relationships. The tools further provide social relationship information. For example, social relationship information may be provided via a graphical user interface, e.g., a graph visually depicting social relationships determined from the social information stored in the database. In several embodiments social relationship information is exposed via an application programming interface (API). In at least one embodiment, the tools may receive social relationship feedback.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to one or more systems, methods, computer-readable instructions, and/or techniques as permitted by the context above and throughout the document.

### BRIEF DESCRIPTION OF THE CONTENTS

The detailed description is presented with reference to accompanying figures. In the figures, the left-most digit(s) of a reference number identifies the figure in which the reference number first appears. The use of the same reference numbers in different figures indicates similar or identical items.

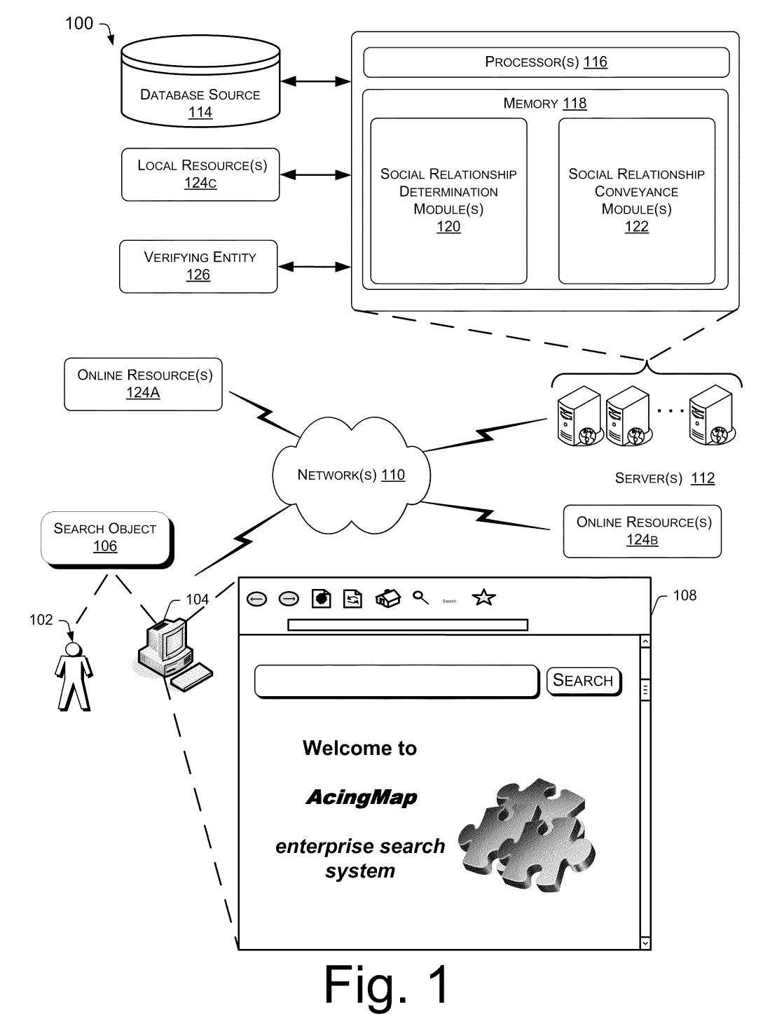

FIG. 1 illustrates an exemplary operating environment for implementing the mining and conveying of social relationships.

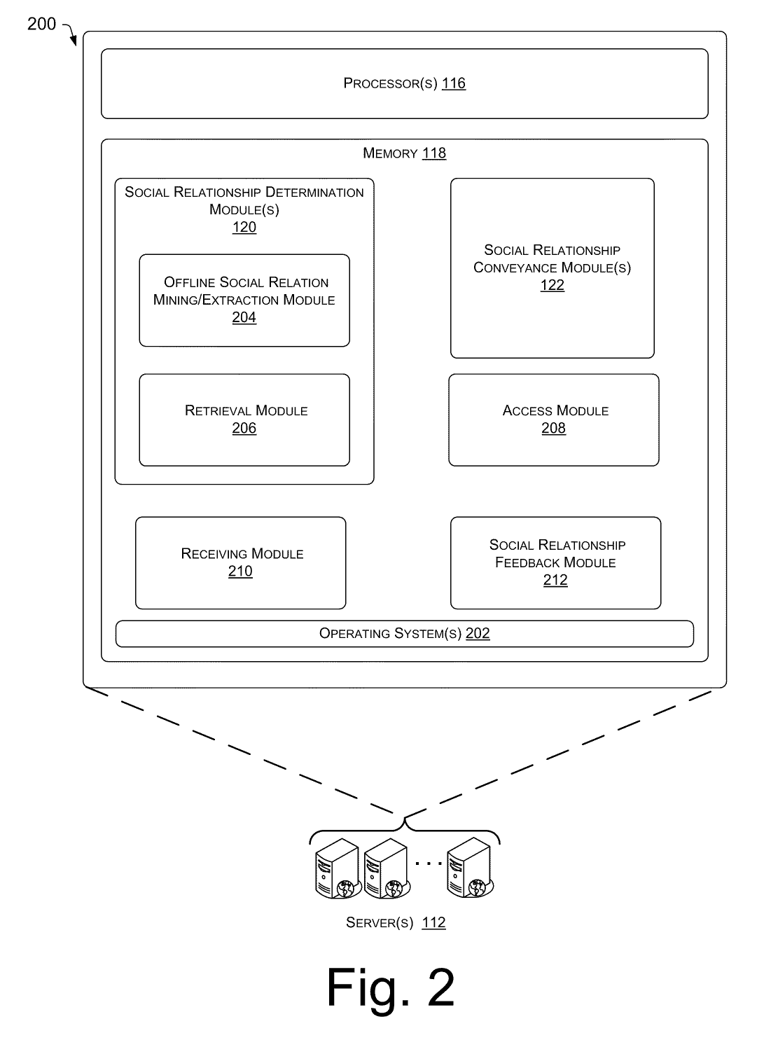

FIG. 2 further illustrates an exemplary computing system implementing the mining and conveying of social relationships.

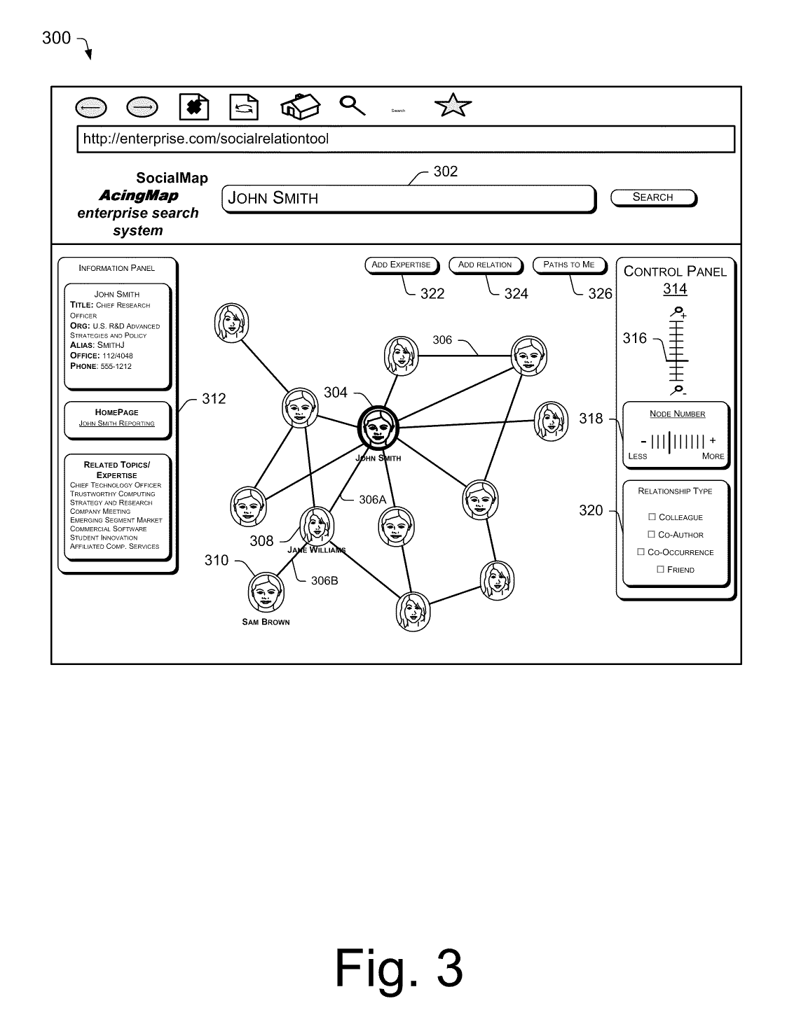

FIG. 3 illustrates one embodiment of a graphical user interface according to this disclosure.

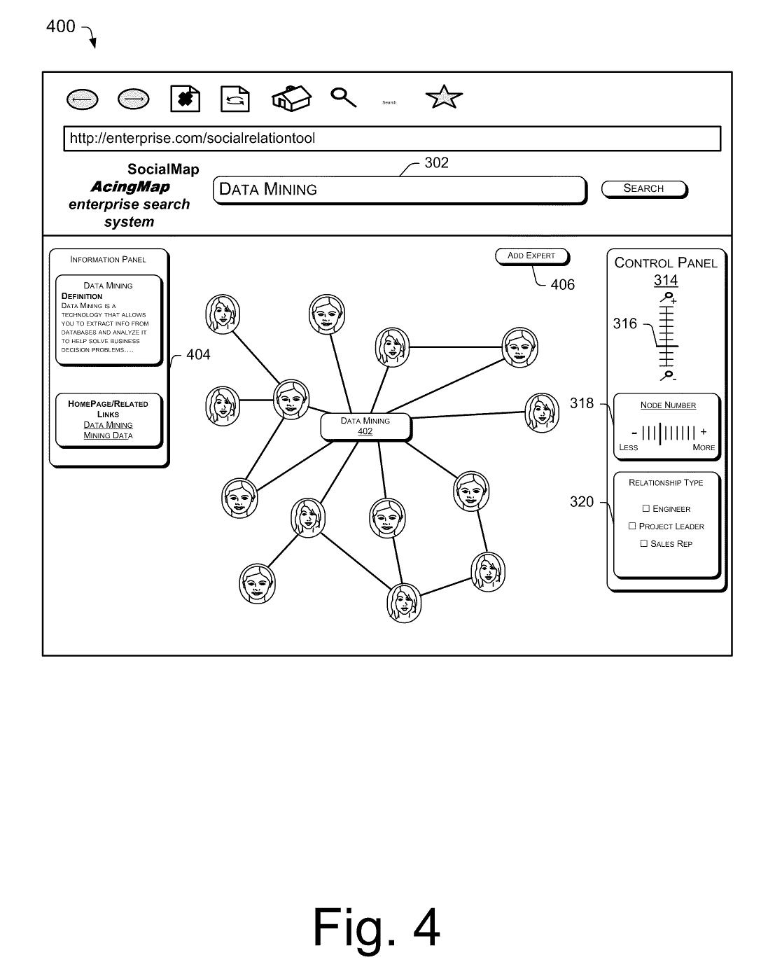

FIG. 4 illustrates another embodiment of a graphical user interface according to this disclosure.

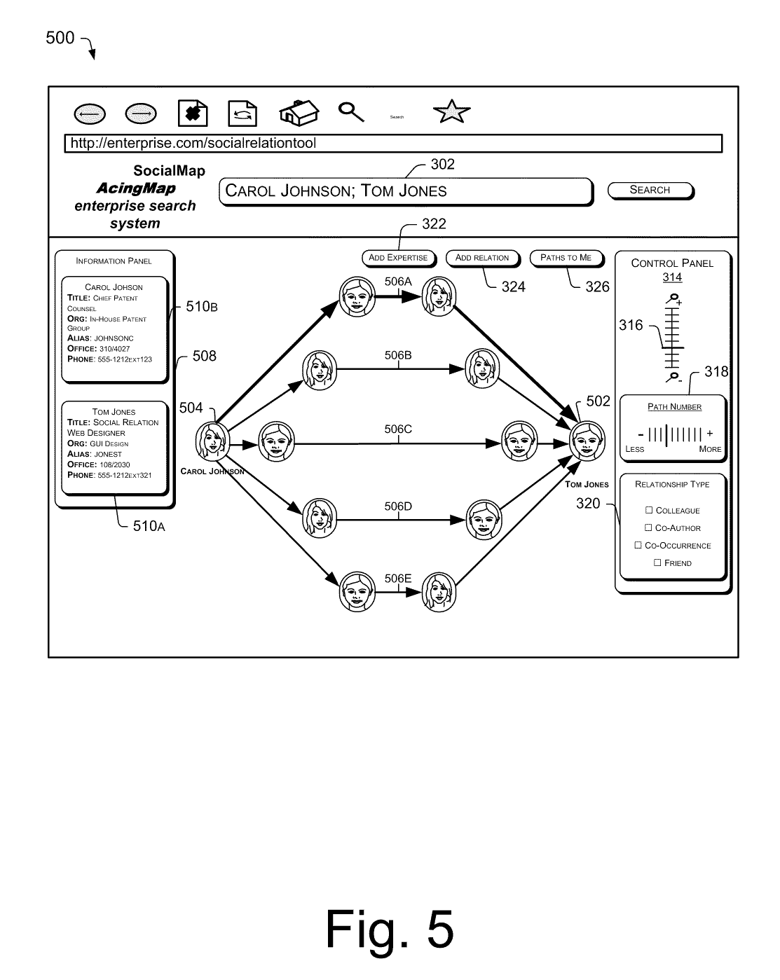

FIG. 5 illustrates yet another embodiment of a graphical user interface according to this disclosure.

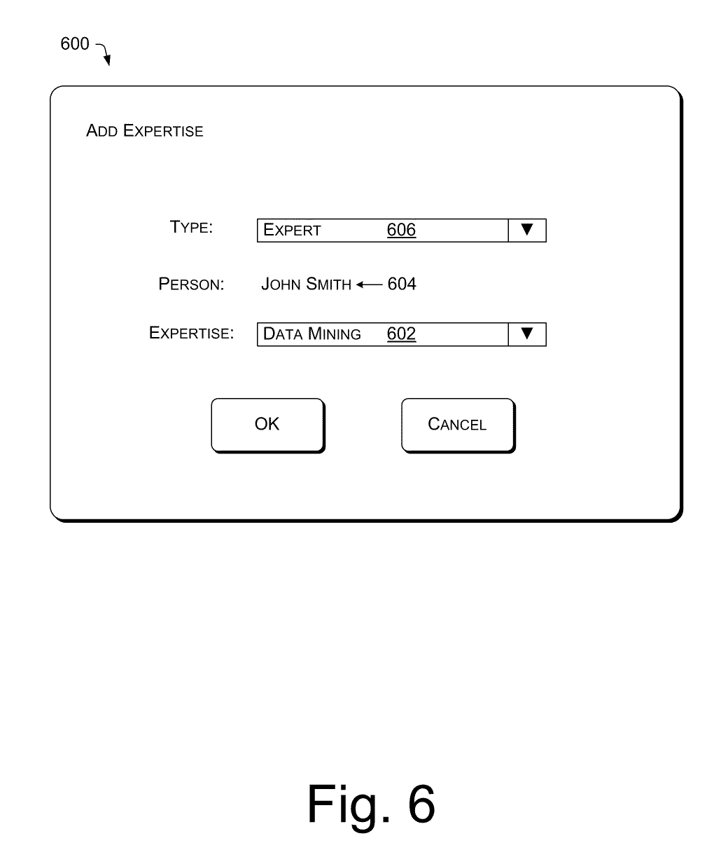

FIG. 6 illustrates an interactive pop-up window according to this disclosure.

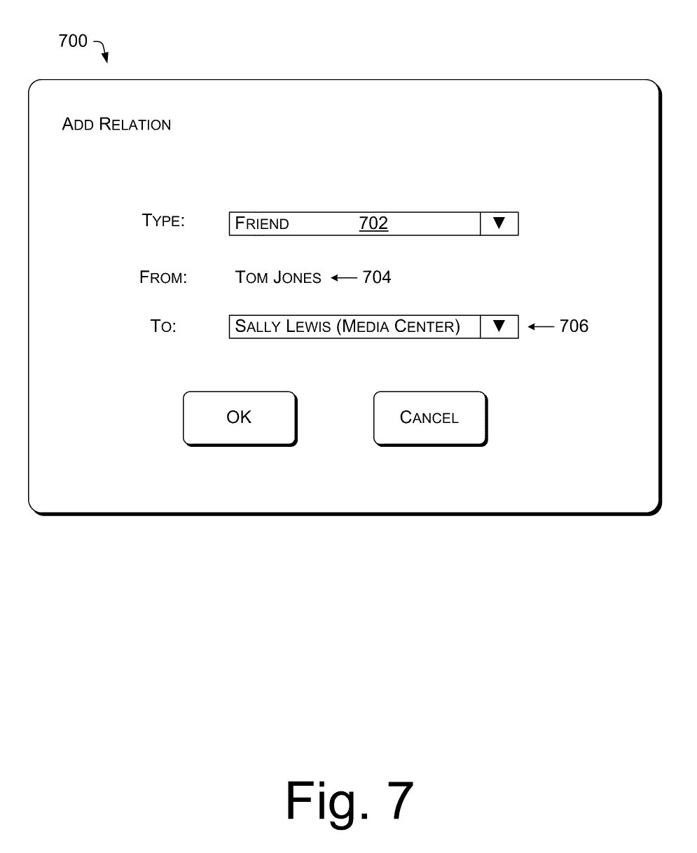

FIG. 7 illustrates another interactive pop-up window according to this disclosure.

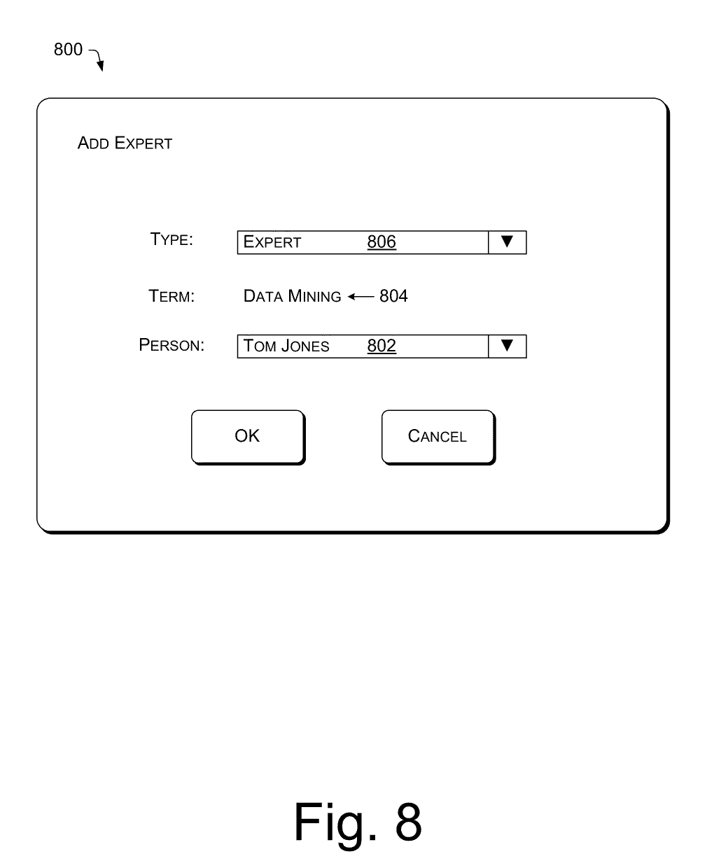

FIG. 8 illustrates yet another interactive pop-up window according to this disclosure.

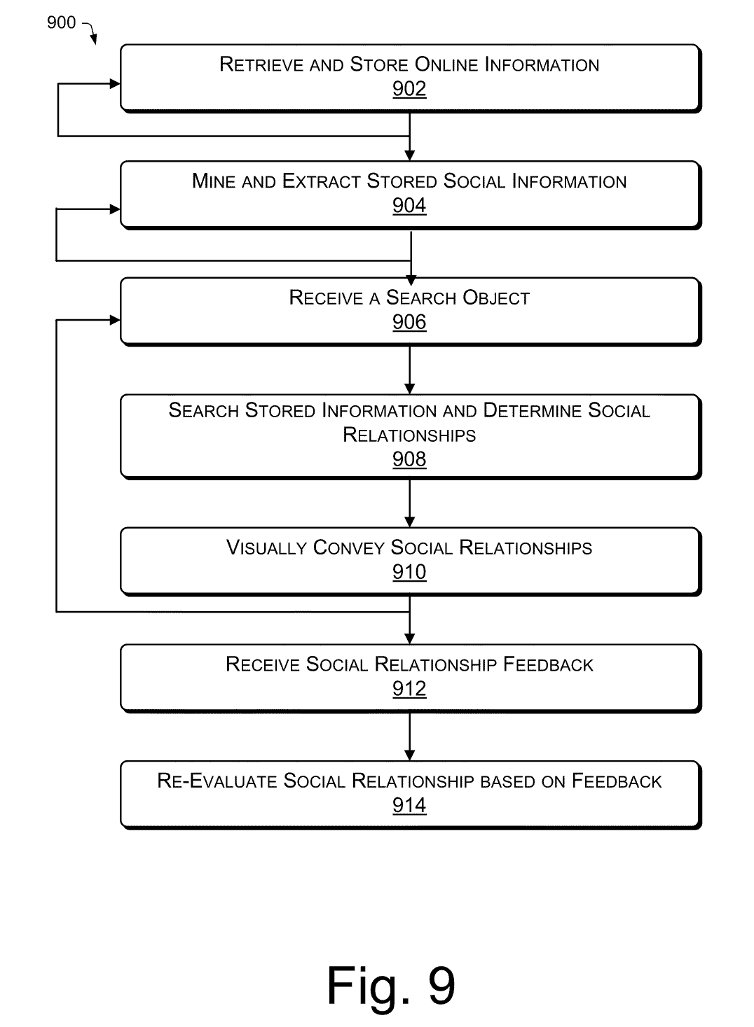

FIG. 9 illustrates an exemplary process implementing the mining and conveying of social relationships according to this disclosure.

### DETAILED DESCRIPTION

### Overview

The following description sets forth tools that mine and extract social information from one or more sources, and store the mined information in a database. The sources may be electronically available sources in an organizational group environment. The tools search the social information and determine social relationships in response to a search object. The social relationships are then made available such as by an API and/or being conveyed to a user. An organizational group environment is a group of two or more people with a common relation. For example, at least two people may be part of the organizational group (e.g. a member of the group), may be connected to the organizational group, may participate in activities of the organizational group, etc. In at least one embodiment, the common relation may be enterprise (e.g. work) related, such as two or more people that work for the same corporation. In at least one other embodiment, the common relation may be a social group, such as members of a sports club. For purposes of this document, the mining of social information and conveying of social relationships is discussed in relation to an enterprise environment. However, this is a non-exclusive example and it is to be understood that the teachings of this document can be applied to various organizational groups or combinations of organizational groups for which information is electronically stored and/or communicated in a computing environment.

Social relationships are relations between people in an organizational group and information about the people in the organizational group. Social relationships help people collaborate and find out information about others because, for example, social relationships may show how a group of people are connected. How one person is connected to others may also be described as that one person's “social network.”

For example, in an enterprise environment, a corporation may have numerous people in different global locations working on a project. One person, with a particular field of expertise may be working on a particular aspect of the project, while another person of a different field of expertise may be working on another aspect of the same project. These two persons may not know each other or be familiar with the other's field of expertise, even though they are working on the same project.

Thus, these two persons, and other people associated with them within the enterprise environment, may not be readily aware or have easy access to social relation information between these two persons. In other words, there is not an efficient way of knowing how these two persons are socially connected. Therefore, it is difficult to determine important social relation information that may be useful when a question needs to be answered for example. The tools described herein mine and extract social relation information, and determine social relationships that may be conveyed to a user so that social relation questions may be answered.

An enterprise environment may include stored documents, emails, network discussion lists and forums, web pages, social profile sites, particular work groups, project groups, etc. These are sources that may provide helpful and useful social information in a computing environment. For example, a work document (including filename and metadata) may include related co-authors, co-occurrence of names in the body of the document, co-occurrence of names within a particular field of expertise in the enterprise environment, anchor text indicating what the work document is about, title, citations to other documents, a check-in history path, etc. An email or string of emails may include a receiver and a sender, people who are part of the email yet not the receiver or the sender (e.g. cc line, subject line, occurrence in body of email), keywords indicating what the email (or string of emails) refers to in the enterprise environment, etc.

Other examples include, network discussion lists and forums that may include multiple postings with bloggers, question askers, question answerers, text directed toward particular topics driving the questions, answers, comments, suggestions in the enterprise environment, etc. Web pages (e.g. Intranet home pages, focus group pages, work group pages, organizational charts) may include authors, intended audiences, directed information, published articles, tagged pictures, links to other information, links to particular professional profiles, etc. Social profile sites may include personal information, status information, professional information, contacts (e.g. professional, social, family, work group, project group), etc.

As described, social information is prevalent within an enterprise environment. An enterprise environment includes multiple sources providing multiple components of stored, posted, or communicated electronic information that may contribute to determining social relationships between multiple people and/or social relationships between a person and a topic of interest (e.g. field of expertise, job title, work group name, experience level, education level, etc.). An enterprise environment may include multiple global corporate offices in multiple geographical locations, multiple corporation departments, multiple job positions, multiple interconnected computing systems, etc.

In at least one embodiment, responsive to receiving a search object from a user via a graphical user interface (GUI), these tools search a database that stores aggregated social information. The tools determine social relationships based on the aggregated social information. The tools then visually convey the social relationships determined from the searched social information via the GUI. For example, the user may enter the name of a co-worker as the search object, and the tools will provide social information relating to the co-worker. In another example, the user may enter a field of expertise within an enterprise environment, and the tools will provide social information about one or more experts (e.g. persons) with knowledge in that field (e.g. technical area, job title, education level, administrative area, work topic, job description, etc.). The preceding examples are not mutually exclusive and therefore, either one or both may serve as a trigger for conveying social relationships.

In at least one embodiment, the tools may give weight to the social information stored in the database when mining the social information from one or more sources. In this sense, the tools may provide, for example by visually conveying different levels of significance and/or strength with regard to multiple social relationships.

For example, when the tools mine the social information, the tools may determine that a sender and receiver of an email have a stronger relationship than the sender of the email and a name listed in the body of the email. In another example, the tools may determine that co-authors of a document have a stronger relationship than the co-occurrence of two names in the body of the same document. In yet another example, the tools may determine that a term associated with a particular person's job title is stronger than the same term that occurs in a project description of another person's profile. Furthermore, a social relationship between a first person and a second person may be determined to be stronger than a social relationship between a first person and a third person because the first person and the second person may be found to be socially related in a larger number of stored social information components.

As discussed in this document, a social relation component is a piece of mined information indicating a social relation. In this sense, a single resource of information such as an email, may include a single social relation component (e.g. receiver and sender of the email), or multiple social relation components (e.g. names in the cc line, names in the body of the email, the recitation of a new project and the project leader). Thus, the tools may mine a resource for multiple pieces of information indicating social relations.

Further resource examples may include a document providing a social relation component corresponding to a first name and a second name in the text of the document. An email sent from the first name to the second name is also a social relation component. The tools aggregate these individual social relation components from multiple different resources when determining a social relationship path between the first name and the second name, for example. Thus a social relationship can be determined from one social relation component, or numerous social relation components. In at least one embodiment, a social relationship path aggregated from numerous social relation components is stronger, more significant, than a social relationship path based on a single social relation component.

Accordingly, the tools may use an algorithm, ranking mechanism, importance determination method or scoring mechanism configured to aggregate and weight the social information components stored, and determine which social relations are more significant. Visually conveying the significance to the user is discussed in greater detail below with regard to FIG. 3-5.

Furthermore, in yet another aspect of several embodiments, the tools may accept social relationship feedback. Once the social relationships are visually conveyed, the tools allow a user to provide feedback associated with one or more relationships. For instance, when the user finds a social relationship to be particularly helpful in response to an entered search object, the user may provide feedback increasing the significance of the social relationship. In contrast, when the user does not find a social relationship to be particularly helpful, the user may provide feedback lessening the significance of the social relationship. Additionally, the user may add (e.g. create, build) social relationships that the mined data did not provide. Accordingly, the tools can provide more accurate results in response to future searches. In at least one embodiment, the feedback provided by a particular user may be set as private feedback, such that the feedback contributes to providing more desired and more accurate results in relation to future searches performed by the particular user. In this sense, the feedback is not utilized in searches performed by users other than the particular user. In another embodiment, the particular user may also contribute public feedback to be used by other users. In this sense, all other users can benefit from the public feedback provided by the particular user.

The following discussion begins with a section entitled “Illustrative Environment,” which describes a non-limiting environment that may implement the claimed tools. A section entitled “Illustrative Graphical User Interfaces” follows and discusses exemplary user interfaces and social graphs (or social networks) that the techniques may employ to convey social relationships to a user. Finally, a section entitled “Exemplary Processes” discusses processes where the tools mine social relation information from multiple sources, receive a search object, search and determine social relationships, and convey the social relationships via the graphical user interface. This brief introduction, including section titles and corresponding summaries, is provided for convenience to the reader, and is not intended to limit the scope of the claims, nor the proceeding sections.

### Illustrative Environment

FIG. 1 depicts an illustrative environment 100 in which the described techniques are employed. As illustrated, environment 100 includes user 102 (e.g. a person or other entity) operating a computing device 104, such as a client computing device. The computing device 104 receives a search object 106 such as by a graphical user interface (GUI) 108. Computing device 104 may comprise one of an array of computing devices capable of connecting to one or more network(s) 110, such as a server computer, a client computer, a personal computer, a laptop computer, a mobile phone, a personal digital assistant (PDA), and the like. Network(s) 110 may comprise, individually or in combination, an enterprise Intranet, the Internet, a Local Area Network (LAN), a Wide Area Network (WAN), a wireless network, and/or the like. While the environment 100 in FIG. 1 depicts a single user 102, it is to be understood in the context of this document that multiple users or entities may enter search objects at multiple different computing devices connected to the network(s) 110.

In illustrated environment 100, user 102 may enter search object 106 via GUI 108. In response to the entered search object 106, one or more servers 112, which may be enterprise servers, individually or in combination, store and have access to database source 114. Database source 114 may be one or more databases that the servers 112 search in order to retrieve and determine social relationship information. In an embodiment where database source 114 represents multiple databases, servers 112 may organize the multiple databases such that each database stores a particular type of social relation component. For example, one database may store social relation components mined from work documents, one database may store social relation components mined from emails, one database may store social relation components mined from discussion forums and so forth. Database source 114 may also comprise multiple databases in which each database stores several types of social relation components and combinations or integrations thereof. For example, one database may store two types of social relation components and another database may store three types of social relation components, etc.

While FIG. 1 illustrates a user 102 entering a search object 106 via a computing device 104 connected to the servers 112 via network 110, it is to be understood in the context of this document that a user 102 can also enter search object 106 directly at the location of the servers 112. Furthermore, while FIG. 1 illustrates a user 102 entering a search object, in at least one embodiment the search object may be entered automatically by a computing device at a configurable time or at predetermined intervals.

As illustrated, the servers 112 include one or more processors 116 and at least one memory 118. Memory 118 stores one or more software modules 120 related to social relationship determination, and one or more software modules 122 related to social relationship conveyance. These modules stored on memory 118 are discussed with greater detail in relation to FIG. 2.

Furthermore, servers 112 may be connected to one or more sources 124. Servers 112 access sources 124 in order to mine and extract social relation components to store in databases source 114. For example, sources 124 may be web servers, email servers, organizational charts, file transfer servers, document storage locations, human resource information, programming databases, call logs, statistical information, instant messaging applications, presence servers, etc. The sources 124 store, maintain, host or have access to the resources as previously discussed (e.g. documents, emails, discussion lists and forums, etc.) In the context of this document, it is to be understood in the context of this document that sources 124 may be any available computing component that can store and/or provide potential social relation components. Furthermore, it is also to be understood in the context of this document that servers 112 may be configured to utilize social relationship determination module(s) 120 to mine and retrieve the social enterprise information (in the form of social relationship components) from any number of available sources 124, although only three sources 124 are shown. Source(s) (e.g. 124A and 124B) may be connected to servers 112 via network 110. Or, source(s) (e.g. 124C) may be directly (e.g. locally) accessible to servers 112. In at least one embodiment, servers 112 access sources 124 at predetermined time intervals.

In at least another embodiment, servers 112 may need to verify a search object in order to resolve an ambiguity. In order to do this, servers 112 may employ a verifying entity 126 to perform verifications. For example, when there are two people in the enterprise environment with the same name, the servers 112 may access the verifying entity 126 to analyze the complete search object and resolve any ambiguity. In this sense, the verifying entity 126 may have access to supplemental information that facilitates resolving an ambiguity. For example, the verifying entity may be a computing component that automatically accesses a human resource (HR) organizational chart and HR records. However, without departing from the scope thereof, it is to be understood that in at least one implementation, verifying entity 126 may be any mechanism to verify an ambiguity. For example, the verifying entity may be a human who manually verifies search object 106, a statistical database, etc.

Thus, the servers 112 employ software and hardware to mine, extract and search social relation information, and convey social relationships determined from the social relation information in response to a search object 106.

The environment 200 in FIG. 2 further illustrates the one or more servers 112 as depicted in FIG. 1. The servers 112 have one or more processor(s) 116 and a memory 118 including at least one operating system 202. The memory 118 stores software modules implementing the techniques discussed in this document with regards to mining social information and conveying social relationships.

Memory 118 is but one example of computer-readable media, and in some embodiments the software modules may be stored on multiple enterprise servers and/or on computer-readable media outside of servers 112. In this sense, servers 112 may include more than one processor 116 and more than one operating system 202. Computer-readable media can be any available media that can be accessed by a computing device such as computing device 104. Computer-readable media includes both volatile and nonvolatile media, removable and non-removable media. By way of example, and not limitation, computer-readable media comprises computer storage media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device such as computing device 104.

In FIG. 2, the social relationship determination module 120 includes an offline social relation mining/extraction module 204 and a retrieval module 206. The retrieval module 206 is configured to locate and access online sources such as 124A and 124B in order to retrieve social information from the resources as previously discussed, and store the social information in database source 114. Social information may also be stored in various data sources such as text files and binary files. As previously discussed, some of the sources 124A and 124B may be online sources (e.g. web pages, discussion lists and forums, servers, etc.) stored in different network locations. Therefore, servers 112 utilize retrieval module 206 to retrieve the social information in an online mode of operation.

In an aspect of at least one embodiment, retrieval module 206 retrieves social information from sources 124A and 124B at a set predetermined time for all sources 124 (e.g. hourly, once daily, weekly, etc.). In another aspect of at least one embodiment, retrieval module 206 retrieves social information from sources 124A and 124B depending on the type of social information from a specific source 124A and 124B. For example, retrieval module 206 may pull information from source 124A every hour because source 124A may be an email exchange server with a high level of email traffic that is constantly updated. On the other hand, retrieval module 206 may pull information from source 124B on a daily basis because source 124B may be a document storage location that may store a very limited number of documents related to a particular topic that is not constantly updated.

Retrieval module 206 may also retrieve social information from local source 124C, and store the social information in database source 114. Indeed, in at least one embodiment, no network resources are needed to retrieve information from source 124C. Similar to the online sources, retrieval module 206 may retrieve social information from source 124C at predetermined times. In at least one embodiment, resource 124A may be directly linked to database source 114.

The offline social relation mining/extraction module 204 is configured to access database source 114, mine the social information stored in database source 114, and produce social relationship(s) responsive to an entered search object 106. The social relationships are produced based on aggregation of one or more separate social relation components as previously discussed.

As previously mentioned, offline social relation mining/extraction module 204 may parse information from a filename, title, metadata or body of text associated with a stored document. Each social relation mined and extracted from the stored document is a social relation component used to determine social relationship paths. In this context it should be understood, that the body of the text may provide additional information (and in some instances more useful and accurate information) compared to the metadata associated with the document, which provides a general description of the text.

Additionally, offline social relation mining/extraction module 204 may parse separate posts in a forum discussion. In this sense, offline social relation mining/extraction module 204 may determine a topic discussion, a question asker, a question answerer, a commenter, etc. Accordingly, offline social relation mining/extraction module 204 may mine and extract multiple social relation components from a stored forum discussion.

In at least one embodiment, offline social relation mining/extraction module 204 mines the social information store in database source 114 at set intervals, for example every 10 minutes. Thus, such mining is not performed in real-time responsive to an entered search object 106. Instead, offline social relation mining/extraction module 204 is able to determine social relationships in advance. This saves valuable processing time and processing resources when a search object 106 is entered. Accordingly, only the search corresponding to a particular search object 106 is performed in real-time.

In at least one embodiment, offline social relation mining/extraction module 204 may be provided to other applications (e.g. third parties) via an API, for example. In this sense the offline social relation mining/extraction module 204 may act as a data provider of basic social relation information to other services and/or applications (e.g. online or local). These other services and/or applications may further manipulate the basic social relation information provided by the offline social relation mining/extraction module 204.

The intervals when offline social relation mining/extraction module 204 mines the stored social relation information may be user configurable, e.g., set by a system administrator, workgroup manager, etc. Examples of parameters for setting such an interval include how often the stored social relation information is updated and retrieved from online sources in the enterprise environment and the size (e.g. number of people, documents, records, etc.) of the enterprise environment.

Social relationship conveyance module 122 includes functionality for providing determined social relationships. For example, visually configuring and providing user 102 with the determined social relationships. In several implementations the social relationship conveyance module 122 may provide the social relationships through an API, in the form of a graph, and/or as a social network depiction. Several examples are further discussed below with respect to FIG. 3-5.

Memory 118 further includes an access module 208 configured to access verifying entity 126 in case there is an ambiguity that needs to be resolved, a receiving module 210 that receives the search object 106 from the user 102 and a social relationship feedback module 212 that utilizes feedback to increase or lessen the importance of a social relationship or add a user-entered social relationship.

Access module 208 may access verifying entity 126 to resolve an ambiguity. In order to resolve the ambiguity, verifying entity 126 may access and analyze supplemental information. In one example, the verifying entity may be a corporate directory or have access to a corporate entity. An ambiguity may arise when there is more than one person with the same name. Another exemplary ambiguity may arise when one expert term has several meanings (e.g. ATM may refer to “Automated Teller Machine” or “Asynchronous Transfer Mode”).

In an event, there are two names entered as the search object 106, and the first name of the entered names is a name corresponding to more than one person, one might expect that the tools may have difficulty indicating the social relationship due to the confusion. However, using the exemplary corporate directory, which may comprise a hierarchal structure corresponding to job positions within the enterprise environment, the verifying entity may determine the distance between the first ‘same’ name corresponding to the first searched name and the second searched name, and the second ‘same’ name corresponding to the first searched name and the second searched name, and determine which path is closer in the hierarchal structure. The closer a path is, the more likely the two are socially related, and hence the more likely the correct social relationship path may be conveyed responsive to search object 102. Although the existence of the alternative social relationship may also be indicated in at least one embodiment. For example, the closer social relationship path may indicate a higher degree of significance than the alternative social relationship.

### Illustrative Graphical User Interfaces

FIG. 3 illustrates an embodiment where the Graphical User Interface (GUI) 300 conveys and displays numerous social relationships to user 102 in response to an entered search object 106. In this embodiment the search object is a single name, “John Smith.” As depicted, user 102 enters the search object via a text entry window 302 configured in the GUI. Responsive to the entry, the social relationship conveyance module 122 provides the user 102 with social relationships. Of course, while GUI 300 depicts thirteen people in the social network, it is to be understood in the context of this document that the social network may include less than thirteen people or considerably more than thirteen people.

In relation to FIG. 3, the GUI visually depicts each person who is socially related (e.g. linked) to John Smith 304. In this embodiment, each node in the displayed graph is connected by a social link such as 306. Each node is a person socially related to John Smith in some capacity. This capacity may be a direct relation, such that there is a direct link between John Smith and another person (e.g. the node corresponding to Jane Williams 308). As illustrated, 306A is an example of a direct link. Or, this capacity may be an indirect relation (e.g. no direct link), such that there are one or more nodes between John Smith and another person (e.g. the node corresponding to Sam Brown 310). As illustrated, 306B is an example of a direct link between Jane Williams and Sam Brown. Thus, link 306A and link 306B represent an indirect relation between John Smith and Sam Brown.

In several embodiments, for example, a direct link means that John Smith and Jane Williams are connected through a direct connection mined from a particular social relation component. For example, John Smith may be the sender of an email and Jane Williams may be the receiver of the email. An indirect relation means that there may not be a direct connection from a particular social relation component relating John Smith and Sam Brown, however, the social relation component may provide an indirect connection through another person. For example, John Smith and Sam Brown may be intended recipients of an email sent by the other person. Thus, they had no direct communication but they are indirectly related because they received the same email.

Additionally, GUI 300 may include an information panel 312 which provides further information associated with the search object, in this example “John Smith” 304. For example, this information may include a title, participation in organizations, alias, office number, phone number, a link to his home page and a list of his expertise (as illustrated). These examples are not exhaustive, and it should be understood in the context of these techniques, that additional supplemental social information relating to an enterprise environment may be provided, e.g., visually displayed in the context of information panel 312.

In another embodiment, GUI 300 may also include section 314, which provides multiple options relating to the social network and social relationships depicted. In several embodiments, all of the multiple options are included in the GUI 300. In other embodiments, only selected options may be included.

A first option 316 allows a user to zoom in or zoom out of the displayed social network or social relationships. This allows the user to see a more detailed view of social relationships when zooming in, or allows them to see a more general view when zooming out. A second option 318 allows a user to increase or decrease the number of nodes based on the weight or significance of the social relationship (discussed in further detail below). For example, the user may only want to see the strongest five social relationships to John Smith. Thus, the user would slide the indicator for option 318 to the “less” side accordingly. A third option 320 allows a user to view the social relationships based on one or more social relationship types. The user employs this option by checking a relationship in the option box 320. For example, if user only wants to view co-author relationships, the user would select the co-author box. In at least one embodiment the selectable options 320 correspond to the social relationship components previously discussed. Selections 322 and 324 represent selection options that will be discussed in further detail regarding FIGS. 6 and 7 respectively, below.

The paths to me selection option 326, allows a user to view one or more social relationships between a search object and herself or himself. The tools as discussed in relation to FIG. 1 and FIG. 2 know the identification of the user logged into the enterprise system. Thus, when the logged-in user enters a search object (e.g. person, term), the tools provide the logged-in user with a social graph or social network based on the search object 106. Now, when the logged-in user selects the paths to me option 326, the tools can determine a social relationship path between the entered search object 106 and the logged-in user, and can visually convey the social relationship path.

Referring again to FIG. 3, user 102 may also switch the search object 102 once the social relationships are displayed responsive to entering John Smith as the search object in text window 302. In at least one embodiment, the user 102 can utilize a mouse or similar user controlled input device to locate and select (e.g. click) a node corresponding to a new person, and subsequently the selected node becomes the search object. For example, user 102 may click the node representing Jane Williams 308. In response, the environment depicted in FIG. 1 and FIG. 2 will search the database source 114 and provide a new set of social relationships. Accordingly, Jane Williams' social information will be displayed in information panel 312. Indeed, user 102 may also switch the search object by entering “Jane Williams” into the text entry window 302.

FIG. 4 illustrates another example where the GUI 400 conveys and displays numerous social relationships such as in response to an entered search object such as 106. In this example the search object is a term “data mining” 402. User 102 may want to search this term in order to locate people socially related with this term. For example, the results may provide one or more people who are socially related to the search object such as they may be considered an expert in the field, members of a project team associated with the search object, etc. It is to be understood in the context of this document that the term entered as the search object can be a single word, or a combination of numerous related words and/or terms. Similar to FIG. 3, user 102 enters the search object via a text entry window 302 configured in the GUI. Responsive to the entry, the social relationship conveyance module 122 provides the user 102 with social relationships.

Similar to FIG. 3, the GUI 400 visually depicts each person (as a node in the graph or social network) who has a social relationship to the search object. For example, in the illustrated example, the search object is the term “data mining” and is shown at 402. Again, each node is connected by a social relationship link. In this embodiment each node may be a person socially related to the searched term, or a node may be another socially related term that the user may be interested in. For example, a common term associated with “data mining” may be “data patterns.” Thus, when user 102 is unable to locate a particular expert in “data mining,” they can be provided with another similar option for a search object.

When switching from a first search term to a second search term, user 102 may want to explore another search option (e.g. “data patterns”), or perhaps user 102 is trying to locate a particular person who is not, for some reason, socially related to the first search term. Again, the relations may be direct or indirect depending on how each person is socially related to the term based on the mined social relation components. In at least one embodiment, the terms (e.g. “data mining” and “data patterns”) may be represented by a symbol.

Additionally, GUI 400 may include information panel 404 which provides further information associated with the search object “data mining” 402. For example, this information may be a definition of the term and any associated home pages. The home pages, for example, may be links to organization or work group sites that work in this field. Again, these examples are not exhaustive, and it is to be understood in the context of these techniques, that supplemental social information relating to the field of “data mining” in an enterprise environment may be visually displayed in the context of information panel 404.

Furthermore, GUI may include section 314. Similar to section 314 in FIG. 3, section 314 provides a first option 316 of zooming in and zooming out, a second option 318 of increasing or decreasing the number of nodes, and a third option 320 of selecting a type (or multiple types) of social relations. In response to the entered term “data mining,” social relationship types may be separated by engineers, project leaders, a sales rep who sells products related to the term, etc. A selection option to add an expert such as by button 406 will be discussed in further detail regarding FIG. 8, below.

Similar to FIG. 3, in FIG. 4 the search object 102 may be switched by selecting a node or entering new text in the text entry window 302.

FIG. 5 depicts an example illustrative of several embodiments where GUI 500 provides social relationships responsive to a search object 106 that includes more than one element compared to the single element entered in FIG. 3 and the term entered in FIG. 4. In at least one embodiment, single element entry, as depicted in FIGS. 3 and 4, is enabled as well as multiple element entries as depicted in FIG. 5. In FIG. 5, two names are entered in the text entry window 302. For instance, user 102 may want to know how “Tom Jones” 502 and “Carol Johnson” 504 are socially related in an enterprise environment.

Responsive to the user entry, the social relationship conveyance module 122 provides the user 102 with social relationships. In relation to FIG. 5, the GUI visually depicts multiple social relationship paths between Tom Jones 502 and Carol Johnson 504. In FIG. 5, the social relationship paths between Tom Jones 502 and Carol Johnson 504 are indirect links. An indirect link may comprise one, two, three, up to N nodes where N is an increasing integer value.

In FIG. 5, the social relationship conveyance module 122 provides five social relationship paths (506A, 506B, 506C, 506D and 506E) between Tom Jones 502 and Carol Johnson 504. In the embodiment depicted in FIG. 5, only the shortest social relationship path between two nodes (e.g. Tom Jones and Carol Johnson) is displayed. In this sense, the five social relationship paths (506A, 506B, 506C, 506D and 506E) are each “tied” for the shortest path because each path has two intermediary nodes. This means that Tom Jones 502 and Carol Johnson 504 are indirectly socially related through the two people in path 506A, the two people in 506B and so forth. According to this embodiment, in an event there is a social relationship path in which Tom Jones 502 and Carol Johnson 504 each know and work with the same person (e.g. one node), then the social relationship path with one node (e.g. the same person they both know) would be the shortest social relationship path and would therefore be displayed instead of the five social relationship paths (506A, 506B, 506C, 506D and 506E) with two nodes. Indeed, the GUI may display one, two, three up to N social relationship paths, where N is an increasing integer, depending on how many paths “tie” for the shortest path between the subject nodes.

Similar to FIG. 3, the GUI 500 in FIG. 5 may include information panel 508 that in this instance provides further information associated with Tom Jones 502 at 510A and Carol Johnson 504 at 510B, respectively, and section 314 which includes zooming option 316, increase/decrease node option 318, and social relation type option 320.

In another example found in several embodiments, a search object can be a combination of the previously discussed examples such as those discussed in respect to FIG. 3, FIG. 4 and FIG. 5. For example, receiving module 210 may receive a term “data mining” 402 and two names such as “Tom Jones” 502 and “Carol Johnson” 504. In this embodiment, the social relationship determination module 120 and the social relationship conveyance module 122 will provide social relationship paths (as depicted in FIG. 5) in which each person represented by a node is an expert in the field of data mining for example. In this sense, the social relation paths displayed are restricted to representing people associated with a particular term or field.

Thus, as seen in relation to the discussion of FIGS. 3-5, a wide variety of search options are provided for identifying social relationships, and in several implementations the social relationships are exposed via APIs. The GUIs in FIGS. 3-5 may further include feedback selection options related to adding an expertise 322, adding a relation 324, paths to me 326 (as illustrated in FIG. 3 and FIG. 5), and adding an expert 406 (as illustrated in FIG. 4).

FIG. 6 depicts a pop-up window that appears when a user selects adding an expertise 322 to a social graph or social network. In this embodiment, a user may either select an existing expertise term listed in a drop-down list or input a new expertise term into entry box 602. In at least one embodiment, the person 604 “John Smith” is automatically inserted based on an entered search object (e.g. the embodiment discussed in relation to FIG. 3), or the person may be manually entered in an event there are two names entered as the search object (e.g. the embodiment discussed in relation to FIG. 5). Entry box 606 allows a user to specify that Tom Jones is an expert in this field. In at least one embodiment, entry box 606 allows a user to specify a level of expertise.

Once the user clicks “OK,” the tools discussed in relation to FIG. 1 and FIG. 2 will build the relationship in the enterprise environment. In an event, the user inputs a new expertise not included in the drop-down list, tools will add the new expertise to the drop-down list.

FIG. 7 depicts a pop-up window that appears when a user selects adding a relation 324 to a social graph or social network. In this embodiment, a user may either select an existing relation type listed in a drop-down list or input a new relation type into entry box 702. In at least one embodiment, person 704 “Tom Jones” is automatically inserted based on an entered search object (e.g. the embodiment discussed in relation to FIG. 3), or the person may be manually entered in an event there are two names entered as the search object (e.g. the embodiment discussed in relation to FIG. 5). Entry box 706 allows a user to specify that Tom Jones is related to Sally Lewis. Entry box 706 may include a drop-down list of suggested people, or allows the user to type in a related person. Accordingly, the tools discussed in relation to FIG. 1 and FIG. 2 builds one or more social relationships in response to the user feedback.

FIG. 8 depicts a pop-up window that appears when a user selects adding an expert 406 to a social graph or social network. In this embodiment, a user may either select a person listed in a drop-down list of suggested persons, or input a new relation type into entry box 802. In at least one embodiment, the term (e.g. field of expertise) 804 “Data Mining” is automatically inserted based on an entered search object (e.g. the embodiment discussed in relation to FIG. 4). Entry box 806 allows a user to specify that Tom Jones is an expert in this field. In at least one embodiment, entry box 806 allows a user to specify a level of expertise.

Thus, the tools as described in this document provide an interactive social system where different search options may be interactively navigated and new social information may be manually added to be stored in database source 114.

In addition to visually conveying social relationships to the user as discussed with relation to FIGS. 3-5, the social relationship conveyance module 122 can be provided via an API plug-in to visually distinguish the social relationships in accordance with their significance. The significance can be configured using simple or complex functions based on the different relation types. In this manner, user or entity 102 may discern, based on the visual distinctions, that one social relationship may be more significant, e.g. stronger, than another social relationship. The significance of a social relationship may be established based in part, on a weight given to social relation information mined by the offline social relation mining/extraction module 204. As previously mentioned, the offline social relation mining/extraction module 204 may give weight to extracted social relation components. In some embodiments such weighting is performed online. Weighting the social relation components contributes to which relationships are stronger in at least one embodiment.

For example, a first person who regularly emails a second person, works within the same project group as the second person, and has co-authored multiple documents with the second person will most likely have a stronger social relationship than the social relationship between the first person and a third person who answered a question posted by the first person on a forum discussion. Thus, when conveying the social relationship as depicted in FIG. 3, it may be beneficial to convey that the second person is more socially connected to the first person than the third person. Thus, a social relationship may be weighted according to a number of social relation components involving the first and second persons. Accordingly, the social relationship connecting the first and second persons may be given a degree of significance based on the weight and the significance may be represented graphically, such as by changes in the color or weight of an individual link or social relationship path, for example path 506A, as presented earlier.

Additionally, the type (e.g. the source and/or resource) social relation information mined may help weight the social relationship. For example, the offline social relation mining/extraction module 204 may give more weight to a social relation component associated with co-authors of a document compared to a social relation component associated with a question asker and question answerer on a discussion forum. Generally speaking, two people who co-author a document or more likely to have a strong social relation compared to a question asker and a question answerer on an online discussion forum. Or, the offline social relation mining/extraction module 204 may give more weight to a social relation component associated with a receiver and a sender of an email compared to a social relation component associated with two names that occur in the body of the same email.

Thus, the offline social relation mining/extraction module 204 may determine which social relationships are more significant based on the number of social relationship components between two people, the type of information that provides the social relationship component, or a combination of both. Furthermore, the significance of these components may also be configured manually. The significance may also be calculated in an online module.

Once the significance has been determined, the social relationship conveyance module 122 may convey the social relationship in way that is helpful for a user to determine which social relationships are more significant. For example, in FIG. 3 and FIG. 4, the people who have more significant relationships with “John Smith” (FIG. 3) and “data mining” (FIG. 4) may be depicted closer to the node representing the search item. Thus, any graphical features that can convey different features representing and distinguishing significance will help user 102 determine which social relationship is stronger. These graphical features may include, but are not limited to distance from the node representing the search object, color of the node representing a person socially related to the search object, style of the node representing a person socially related to the search object, style, bolded path links between two or more nodes, flashing path links between two or more nodes, highlighted path links, etc.

These distinctive graphical features may also be applied in FIG. 5. Although FIG. 5 depicts five social relationships path based on how Tom Jones 502 and Carol Johnson 504 are connected, the social relationship conveyance module 122 may use one of the described features to convey a more significant social relationship path based on the weighting as previously discussed.

### Illustrative Processes

Exemplary operations are described herein with reference to FIG. 9. The processes are illustrated as logical flow graphs, which represent a sequence of operations that can be implemented in hardware, software, or a combination thereof. In the context of software, the operations represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 9 depicts an illustrative process 900 for retrieving social information from multiple sources, mining the retrieved social information in order to determine social relationships, and conveying the social relationships responsive to a received search object.

At 902, retrieval module 206 retrieves and stores social information from one or more sources. As illustrated in FIG. 1, the sources may be online sources 124A and 124B, or local sources 124C. As previously discussed, retrieval module 206 may retrieve the social information at predetermined time intervals depending on the type of information provided by the source. Thus, the retrieval module 206 may continually retrieve and store social information as illustrated by the re-occurring arrow.

At 904, offline social relation mining/extraction module 204 mines and extracts social relationships from the stored social relation information. The social relationships can be weighted so that more significant (e.g. stronger) relationships can be determined. Similar to the retrieving module 206 retrieving social information at predetermined time intervals, offline social relation mining/extraction module 204 may mine the stored social relation information at set intervals. Thus, the offline social relation mining/extraction module 204 may continually mine the stored social information as illustrated by the re-occurring arrow.

In at least one embodiment the retrieving time intervals and the mining time intervals may be coordinated to provide updated social relationships while preserving processing resources and time. Accordingly, these time intervals are user configurable in such embodiments.

At 906, receiving module 210 receives a search object. As depicted in FIG. 1, user 102 may provide search object 106 via GUI 108. Exemplary search objects are discussed in relation to FIG. 3-5.

At 908, offline social relation mining/extraction module 204 searches the stored information and determines one or more social relationships based on the received search object 106. In several embodiments, the search and determination is done in real-time once the search object is received.

At 910, the social relationship conveyance module 122 visually conveys the determined social relationships. In at least one embodiment, the social relationships are displayed to user 102 via GUI 108 as illustrated in FIG. 1. FIGS. 3-5 provide exemplary social relationship graphs or social networks. When the user 102 changes the search object via a mouse click or new text entry, then the process goes back to 906 and a new search object is received.

At 912, receiving module 210 receives social relationship feedback. The social relationship feedback may be user provided (e.g. via the GUI) such that it is intentional, or the social relationship may be automatically determined by the servers 112.

In a first example, social relationship conveyance module 122 may provide user 102 with the social relationship graph as illustrated in FIG. 3. The user may explore a social relationship that is useful (e.g. helpful, informational, etc.), but also may explore a social relationship that he/she thought would be useful, but ultimately was not. Accordingly, user 102 may vote up or vote down a social relationship via a selection option configured via the GUI as a selection area (not shown). In this sense, the social relationship determination module 120 and the social relationship feedback module 212 may continue to receive user provided social relationship feedback, and thus, be able to adjust the significance of the social relationships based on the feedback.

Indeed, feedback received over a longer period of time from numerous different users will provide a stronger indication of whether a particular social relationship is significant (e.g. important). Thus, the social relationship determination module 120 may store the social relationship feedback received until a certain amount (e.g. threshold) of feedback received is sufficient enough to adjust the significance of the particular social relationship. In at least one embodiment, the social relationship determination module 120 may categorize the feedback. Exemplary categories may include, but are not limited to, good, not good, positive, negative, etc.

In a second example, receiving module 210 may receive an added social relationship provided by a user. Referring to FIG. 5, for example, in an event a user knows a closer social relationship path than those illustrated, than the user can manually add (e.g. provide) the closer path. For example, the user may know that Tom Jones 502 and Carol Johnson 504 know a common person. Thus, the social relation path between Tom Jones 502 and Carol Johnson 504 (via the commonly known person) is one node. This path is closer than each of the five two nodes path illustrated in FIG. 5. Thus, the user may add the closer social relationship path so that subsequent searches will provide more useful social relationships.

While the first and second example discussed related to user-provided social relationship feedback, the social relationship feedback may also be automatically deduced in at least one embodiment. Referring to FIG. 4 for example, when multiple users have entered the term “data mining” 402 and consistently clicked on the same first node (e.g. person) in search of an expert in this field, without switching to a second node in hope of locating a more experienced expert. In this example, the social relationship determination module 120 may automatically determine that the first node consistently selected must be a significant social relationship based on the fact that user entering the term are not switching from one node to another when apparently searching for an expert.

At 914, the social relationship determination module 120 re-evaluates one or more social relationships based on the received social relationship feedback. As previously discussed, the social relationship determination module may adjust the significance of the social relationships. This may be done immediately upon reception of the feedback, or may be stored over time and performed once a certain amount of feedback has been received.

In at least one embodiment, offline social relation mining/extraction module 204 may analyze the social relationship feedback and determine which sources and/or resources the social relationship was mined from. In this sense, the offline social relation mining/extraction module may adjust how it weighs social relation components from these sources and/or resources.

For example, when consistent negative social relationship feedback is received in relation to social relationships mostly based on mined information from a particular discussion forum, then offline social relation mining/extraction module 204 may determine to lessen the weight (e.g. lessen the importance) of social relation components mined from that discussion forum.

In contrast, when consistent positive social relationship feedback is received in relation to social relationships, for example mostly based on emails, then the offline social relation mining/extraction module 204 may determine to strengthen the weight of social relation components mined from emails. In at least one embodiment the weight adjustment may be based on emails from a particular domain name, group, or a particular email exchange server. In this way, the offline social relation mining/extraction module 204 may grade or evaluate the sources and resources it mines for social information.

In at least one embodiment, the mined social relationships and the social relationship feedback may be shared with other applications and/or systems outside the enterprise environment, such as by exposing the social relationship information and feedback through APIs.

### Conclusion

Although the subject matter has been described in language specific to structural features and/or methodological acts, it is to be understood that the system and method defined in the appended claims is not necessarily limited to the specific features or acts described. Rather, the specific features and acts are disclosed as exemplary forms of implementing the claims. For example, in at least one embodiment, the example 300 as discussed regarding FIG. 3, may be implemented independently of examples 400 and 500 as discussed regarding FIG. 4 and FIG. 5. However, in other embodiments, examples 400 and 500 may be implemented in conjunction with, example 300.

1. A method of providing social relationships in an enterprise environment, the method comprising:
mining a set of data stored in a database, the set of data originating from multiple sources;
receiving, via a graphical user interface (GUI), a search object;
responsive to receiving the search object, visually providing via the GUI, one or more social relationships associated with the search object;
receiving feedback corresponding to at least one of the social relationships; and
reevaluating the at least one of the social relationships based on the received feedback.

2. The method of claim 1, wherein the search object comprises at least one of the following:
a first name;
a second name;
a field of expertise within the enterprise environment;
a work group leader;
a project leader; or
a department leader.

3. The method of claim 1, further comprising providing the one or more social relationships associated with the search object according to, significance, the significance being visually distinguished via a configuration of the GUI.

4. The method of claim 1, wherein the one or more social relationships comprise a plurality of nodes, each node representing at least one of the following:
a person associated with a first name;
a person associated with a second name;
a term or a symbol associated with a field of expertise in the enterprise environment;
a person associated with a work group leader;
a person associated with a project leader;
a person associated with a department leader; or
a person that is not a direct part of the search object, yet is associated with a social relationship path between two nodes that are part of the search object.

5. The method of claim 4, wherein a social relationship path with the fewest nodes comprises a most significant social relationship.

6. The method of claim 1, wherein mining the set of data is performed at predetermined time intervals, and providing the one or more social relationships is performed in real-time.

7. The method of claim 1, further comprising:
displaying one or more nodes corresponding to the one or more social relationships;
receiving an indication of a selected node;
responsive to the indication, determining an updated set of the one or more social relationships by searching the set of data stored in the database, the updated set of the one or more social relationship paths corresponding to a focus switch from the search object to the selected node; and
responsive to the focus switch, visually providing, via the GUI, the updated set of one or more social relationships.

8. The method of claim 1, wherein the feedback comprises at least one of the following:
a vote up increasing the significance of the at least one of the social relationships;
a vote down lessening the significance of the at least one of the social relationships; or
a manual entry of a social relationship not visually depicted via the GUI.

9. The method of claim 1, further comprising:
in an event an ambiguity associated with the search object is introduced:
accessing a verifying entity; and
resolving the ambiguity via the verifying entity by analyzing supplemental information.

10. The method of claim 1, wherein the set of data is retrieved from multiple sources according to at least one predetermined time interval.

11. The method of claim 10, wherein the at least one predetermined time interval is based at least on a type of information provided by at least one of the multiple sources.

12. One or more computer-readable storage media comprising computer-executable instructions that when executed by a processor, perform the method of claim 1.

13. A graphical user interface (GUI) implemented as part of a computing system, the GUI configured to provide via a display, one or more social relationships in an enterprise environment, the GUI controlled by modules comprising:
a determination module configured to mine a set of data stored in a database, the set of data being retrieved from multiple sources;
a receiving module configured to receive a search object;
a conveying module configured to visually provide the one or more social relationships associated with the search object; and
a social relationship feedback module configured to receive input relating to at least one social relationship.

14. The GUI of claim 13, wherein the search object comprises at least one of the following:
a first name;
a second name;
a field of expertise within the enterprise environment;
a work group leader;
a project leader; or
a department leader.

15. The GUI of claim 13, wherein the one or more social relationships comprise a plurality of nodes, each node representing at least one of the following:
a person associated with a first name;
a person associated with a second name;
a term or a symbol associated with a field of expertise in the enterprise environment;
a person associated with a work group leader;
a person associated with a project leader;
a person associated with a department leader; or
a person that is not a direct part of the search object, yet is associated with a social relationship between two nodes that are part of the search object.

16. The GUI of claim 13, wherein:
the conveying module is further configured to display one or more nodes corresponding to the one or more social relationships;
the receiving module is further configured to receive an indication that a user has selected one of the one or more nodes;
responsive to the indication, the determination module is further configured to search the set of data stored in the database and determine an updated set of one or more social relationships, the updated set of one or more social relationships corresponding to a focus switch from the search object to the node selected by the user; and
responsive to the focus switch, the conveying module is further configured to visually provide the updated set of one or more social relationship paths.

17. The GUI of claim 13, further comprising an accessing module configured to access a verifying entity to resolve an ambiguity associated with the search object.

18. The GUI of claim 13, wherein the user input comprises one of the following:
a vote up supporting the significance of the at least one social relationship;
a vote down lessening the significance of the at least one social relationship; or
a manual entry of a social relationship not visually depicted via the GUI.

19. A system that provides social relationships in an enterprise environment, comprising:
one or more processors;
one or more computer-readable storage media comprising computer-executable instructions;
a graphical user interface (GUI) configured to receive a search object and convey one or more social relationships; and
a social relationship determination module configured to mine a set of offline data and determine the one or more social relationships.

20. The system of claim 19, wherein the system is configured to retrieve online information prior to mining the set of offline data.
